(19) United States
(12) Patent Application Publication
(10) Pub. No.: US 2002/0087420 A1
(43) Pub. Date: Jul. 4, 2002

(54) Integrated selling system

(76) Inventors: Michael S. Higgins, Atlanta, GA (US); Bruce N. Miller, Decatur, GA (US)

Correspondence Address: Donald E. Hayes, Jr., 3097 Wembley Ridge, Atlanta, GA, 30340, US

(21) Appl. No.: 09/752,279

(22) Filed: Jan. 2, 2001

(51) Int. Cl. G06F 17/60

(52) U.S. Cl. 705/26

(57) ABSTRACT

The present invention relates to an integrated selling system that synergistically combines highly visible product signage with an information retrieval system. The signage displays an identification character string, “code,” which specifically corresponds to the product being sold. The information retrieval system provides the seller with a designated section to input and store specific, detailed data relating to the product being sold. A potential buyer sees the signage on or near the product being sold and takes notice of the identification character string. By inputting this identification character string into the information retrieval system, the potential buyer gains access to specific, detailed information about that product. The combination of these two components significantly enhances the success rate of a seller finding potential buyers and providing them with the specific information necessary to complete the sale.

### FIELD OF THE INVENTION

The present invention relates to a novel system for selling products. More specifically, this invention provides a unique method for an individual or company to advertise products for sale to potential buyers and allow these potential buyers convenient access to detailed product information through the coordination of various communications media.

### BACKGROUND OF THE INVENTION

Sellers of products today have essentially two major methods of marketing their product to the general public: The seller may choose to place an advertisement through a selected media, such as newspapers, periodicals, radio and/or television—or the seller may put a “For Sale” sign on the product itself. However, each of these media forms has severe limitations in their ability to both attract potential buyers and fully inform these potential buyers of all the relevant information about the product within the cost/space constraints of the media.

With the first marketing method—conventional media advertising—newspapers and periodicals carry legitimate cost/space constraints and are only visual with no audio. Radio and television commercials, on the other hand, have prohibitive cost/time restraints and, except for long-length “infomercials,” limit the information received by the potential buyer and thus the likelihood of a sale.

While the cost/space constraints of conventional media advertising adversely affect the sale of nearly all types of products, they can be easily illustrated with the sale of vehicles. Private sellers of automobiles and trucks are at a disadvantage compared to vehicle dealers who can purchase large display ads in newspapers. Private sellers are typically constrained by cost to a minimum size classified advertisement with approximately 80 characters of copy. For example:

FORD TAURUS GL 1994 $3995

white, lthr, loaded, nu trans, runs

excellent, 98 K, 404-555-5555

The second common marketing method used by sellers is to affix a visually prominent sign on or near the product. One of the most frequently seen examples of this is the common practice of placing a “For Sale” sign in the window of an automobile. However, there are a number of problems inherent in this method that prohibits effective communication of the product information necessary to persuade a potential buyer to purchase the product. First, since most people see automobiles when they are moving on public streets and highways, it is impractical for fellow drivers to ascertain detailed, specific data about the product being sold. Therefore, affixed signs often fail in their attempt to both capture the attention of potential buyers and convey the necessary information needed by a buyer to complete a sale.

Safety is another concern regarding signs affixed in vehicles beyond their arguable ineffectiveness. Affixing a standard 140 square-inch “For Sale” sign inside the vehicle's rear or side window obscures the driver's rear field of view and impedes safe driving. In addition to this safety hazard, window signs present several more practical inconveniences for the users. Side windows become inoperable when a tape-affixed window sign warps in the sun. Unattractive taped window signs cannot be quickly removed for special occasions. Dried tape and adhesive must be scraped off windows with a razor.

Most importantly, from a selling point of view, the affixed-sign method of advertising unfortunately results in lost selling opportunities. Hand-scrawled signs are difficult to read through tinted glass by other drivers at safe following distances. As a result, the vast marketing potential of essentially free advertising on public roads is lost.

In addition to the problems referenced above, there is an overriding concern among many private-party sellers regarding privacy. Both media ads and conventional signs create privacy concerns for private sellers by exposing home phone numbers to the general public. Signs, in particular, create a privacy risk by visibly linking the driver behind the wheel to the phone number on the window. Many sellers choose to trade in their vehicle to a dealer, despite the financial disadvantage, simply to avoid the risks and hassles of fielding phone calls from the general public.

### SUMMARY OF THE INVENTION

In accordance with the present invention, the limitations of the prior art are avoided by means of an integrated selling system that synergistically combines highly visible signage with an information retrieval system. The signage displays an identification “code” which specifically corresponds to the product being sold. The information retrieval system provides the seller with a designated section to input and store in-depth, detailed data relating to the product being sold. A potential buyer sees the signage advertising the product being sold and takes notice of the identification “code.” By inputting this “code” into the information retrieval system, the potential buyer gains access to in-depth text information and photo views of that product. The combination of these two components significantly enhances the success rate of a seller finding potential buyers and providing them with the information necessary to complete the sale.

### BRIEF DESCRIPTION OF THE DRAWINGS

The various objects, advantages and novel features of this invention will be more readily apparent from the following detailed description when read in conjunction with the enclosed drawings and appendices, in which:

FIGS. 1a and 1b are graphical depictions of companion signs that may be used in accordance with the present invention;

Appendix 1 is an illustration of a form that may be used by the seller to create an online ad to facilitate the sale of a vehicle in accordance with a preferred embodiment of the present invention;

Appendix 2 provides a version of a form for the seller to input in-depth, detailed data about the vehicle being sold;

Appendix 3 assists a seller in incorporating photographs of their product into their individualized portion of the information retrieval system in accordance with a preferred embodiment of the present invention;

Appendix 4 depicts a sample feedback that allows the seller to review the previously entered data; and

Appendix 5 displays what potential buyers will see when they access the information retrieval system with the seller's individualized identification character string in accordance with a preferred embodiment of the present invention.

### DETAILED DESCRIPTION OF THE PREFERRED EMBODIMENT

The improved selling system of the present invention uses high-visibility signage on or near a product being sold in conjunction with a uniquely coordinated information retrieval media to create a novel integrated selling system. Together, the seller's signs and the electronic information retrieval system work together to maximize the visibility of the available product and allow potential buyers immediate access to detailed product information, thus significantly enhancing the possibility of finalizing a sale. The integrated selling system of the present invention provides an advantageous method for an individual or company to alert potential buyers to their products' availability and, most importantly, allows these potential buyers to conveniently obtain specific detailed data about the product through the coordination of multiple communications media.

Structurally, the present invention includes a number of different specific components that are interconnected and utilized in a manner that produces a synergistic effect toward the sale of a product. In general, the preferred embodiment of this invention includes at least the following components: 1) a uniquely designed sign assembly acting as a visual depiction of the seller's intent to sell a given product; and 2) an information retrieval system uniquely coordinated with the seller's sign to conveniently provide product information.

One aspect of the present invention that facilitates a synergistic result from the combination of signage and an information retrieval system is the overriding control provided to the seller in determining the information both displayed on the signage and presented through the information retrieval system. The seller is provided with all of the necessary materials, namely lettering and numbers, to create their sign as desired. Additionally, the seller is given access to a portion of the information retrieval system that is designated exclusively for information regarding their product.

The seller directly inputs and stores information about the product they are selling into their designated portion of the information retrieval system. Since the seller is in complete control of this process, they alone decide what information is best to include and which data to specifically emphasize to enhance the probability of completing a sale. Additionally, the design of the present invention allows a seller to reap the full benefits of this novel integrated selling system while personally maintaining total control over what private information is divulged.

Two acceptable media forms suitable for use as the information retrieval system include Internet connections and telephone connections. However, although only two specific types of retrieval systems are set forth immediately above, the present invention does contemplate the incorporation of other commonly-used media forms capable of storing and presenting vital data to a potential buyer about a selected product based on information ascertained from the seller's sign.

The preferred embodiments of the present invention detailed herein are directed toward the sale of vehicles. Vehicles that can be sold through the system include, but are not limited to automobiles, trucks, boats and private aircraft. While the vehicles listed above are exemplary of the preferred embodiments of the present invention, the present invention is no way limited to only vehicles, but intended to provide improved selling of many other types of products as well.

To further highlight the novel features of a preferred embodiment of the present invention, an example is detailed below illustrating specifically how the use of the unique integrated selling system described and claimed herein significantly enhances the sale of an automobile. The particular features of each of the components, namely the high-visibility signage and the electronic information retrieval system, and specifically their unique relationship with each other as used in the sale of an automobile are set forth below.

High-visibility Signage

In a preferred embodiment, the selling system of the present invention uses a series of signs that may magnetically affix to a variety of vehicle surface locations depending on the vehicle style and user preference. Ideally, the signs are dimensioned to fit onto the rear surfaces of most vehicles and are created with large pre-formatted vinyl adhesive lettering to facilitate easy viewing by drivers in other vehicles. Additionally, the design of the pre-formatted vinyl adhesive lettering allows for each seller to conveniently customize the information displayed on the sign such as price, make, model, year, mileage, etc.

Most importantly with regard to the present invention, the magnetic signs clearly set forth identifying data which enables a potential buyer to directly activate the designated portion of the associated information retrieval system coordinated with that seller's signs. The use of such carefully coordinated identifying data links each product being sold with more detailed information associated only with that particular vehicle being sold. For example, each seller places a specific character string on their individualized signs which uniquely identifies the “code” necessary to access an area within the electronic information retrieval system where detailed information can be found regarding only the product associated with the sign exhibiting that “code.”

As mentioned above, the seller determines the information set forth on the sign. This control allows each seller to decide what character string to use as his or her personal identification “code.” One common choice for the “code” may be the seller's telephone number. Such a choice would additionally allow potential buyers to access the seller directly via telephone, even by using a wireless telephone while traveling down the road near the vehicle displaying the seller's sign. However, any seller that is concerned about publicly divulging their personal telephone number, may, in accordance with the present invention, simply select some other character string as the “code” to allow potential buyers access to the seller's designated portion of the information retrieval system. This “code,” displayed on the sign by the seller, is input by potential buyers into the information retrieval system to obtain specific, detailed data about the vehicle being sold.

In addition to the information transfer issues discussed above, the magnetic signs are designed with many practical and safety-related features in mind. However, each of these features is implemented without adversely affecting the ability of this invention to capture the attention of a potential buyer and provide ready access to more specific product information. Among some of these features envisioned for use in a preferred embodiment of the present invention are: a) the signs are designed and positioned so as to not obscure the driver's field of view; b) the signs can be attached or removed in an instant; and c) upon removal, the signs leave no messy adhesive residue.

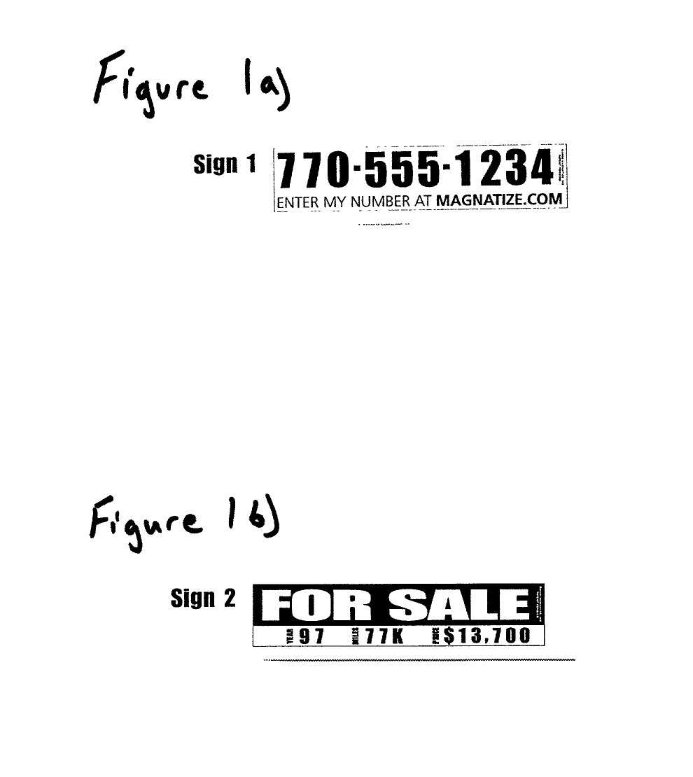

In one preferred embodiment of the present invention, two companion signs are employed. On one sign, the seller positions their identification “code,” such as telephone number when no privacy concerns exist, while the second sign is a “For Sale” sign with areas for the seller to place the most basic product data, such as make, model, price, etc. One specific design of these companion signs is set forth below and visually depicted in FIGS. 1a and 1b:

each of the signs is a 14″ long by 3″ tall 0.020 mil magnetic sheeting;

one sign uses 2″ high letters for displaying identification data, i.e. phone number and the other sign uses 1″ high letters for displaying product information;

letters are PMS 186 Red (UV ink) printed on UV self adhesive permanent vinyl sheeting;

“FOR SALE” is reversed white letters out of a red background for increased visibility.

Electronic Information Retrieval Systems

As stated earlier, the present invention not only uses specifically designed “For Sale” signs, but also, most importantly, these signs are uniquely coordinated with a selected electronic information retrieval system. In the preferred embodiment of the present invention, two of the specific types of media suitable for use are the Internet and/or a toll-free telephone number. These two media forms may be used either alone or in combination with each other to store very detailed information about the product being sold in a manner that potential buyers can readily access via the “code” prominently displayed on the signage affixed to that product.

In the preferred Internet mode of the information retrieval system, the prospective buyer notes the unique identification character string and Web address prominently displayed on the seller's sign on or near the product. The buyer visits the system's Web site and enters the identification code. Upon entering the identification code or character string for the product, the buyer is presented with detailed information about that particular product. This detailed information has been loaded into this Web location directly by the seller.

Given the ever-changing enhancements to Web technology, the seller has complete flexibility regarding the content and form of the product information available to potential buyers. Information can be presented using an almost unlimited combination of text, video, audio, and/or visual graphics. Some specific examples of information likely valuable for inclusion on an automobile sale may include multiple photographs of the vehicle, full list of notable features of the vehicle, extensive maintenance and repair history, etc. Additionally, the online ad controlled by the seller allows the buyer to contact the seller via an email link or directly by phone depending on the seller's preference concerning privacy.

To further illustrate the practical application of the present invention utilizing the Internet as the information retrieval system, sample Web pages are set forth in Appendices 14. Appendix 1 illustrates a form that may be used to create an online ad to facilitate the sale of a vehicle. Appendix 2 provides a version of a form for the seller to input specific, detailed data about the vehicle being sold. Appendix 3 assists a seller in incorporating a photograph of their product into their individualized portion of the information retrieval system. Appendix 4 allows for review of the previously entered data. In addition, Appendix 5 displays what potential buyers will see when they access the information retrieval system with the seller's individualized identification character string.

In the toll-free telephone number embodiment of the system, the prospective buyer notes the system's toll-free number and unique seller identification code listed on the vehicle signs. The buyer enters the code and receives detailed audio information about the product. If the buyer wishes to pursue the vehicle sale further when the seller is unavailable, the buyer leaves a voice message on the system. The utilization of the aforementioned type of messaging system, the messages are stored and can be reviewed by the seller at a later time. Additionally, the seller has the freedom to respond only to messages they choose to.

Seller protection is also enhanced by a Caller-ID system that notes the prospective buyer's source phone number and telephone directory listing as a digitized audio tag to each message. The seller does not need to subscribe to a particular telephone feature such as Caller-ID from their phone company to utilize this feature. Lastly, each of the information retrieval systems contemplated for use with the present invention and described herein are capable of shielding the seller's private phone number from public exposure.

In addition to the synergistic effect realized from the unique combination of high-visibility signage and a coordinated information retrieval system, the novel integrated selling system of the present invention also includes important materials which provide invaluable support for private party sellers. Included among these is a comprehensive How-to-Sell Your Vehicle booklet, a Bill of Sale and a Deposit/Terms of Sale Agreement. Taken as a whole, the novel selling system of the present invention both significantly enhances the success rate and simplifies the process of selling a product, such as a used vehicle, while protecting the seller's privacy.

Although the present invention has been described with reference to a preferred embodiment, the invention is not limited to the details thereof. Modifications that may occur to those skilled in the art are intended to fall within the spirit and scope of the invention as defined in the appended claims.

What is claimed is:

1. An integrated selling system comprising:
signage on or near a product to be sold wherein the signage displays an identification character string associated with the product being sold; and
an information retrieval system which is activated upon receipt of the identification character string.

2. The integrated selling system of claim 1 wherein the information retrieval system is capable of receiving and storing information about the product being sold.

3. The integrated selling system of claim 2 wherein input of an identification character string into the information retrieval system accesses a portion of the information retrieval system containing information exclusive to the product displaying that particular identification character string input into the retrieval system.

4. The integrated selling system of claim 2 wherein the person selling the product generates the identification character string on the sign.

5. The integrated selling system of claim 2 wherein the person selling the product generates the product information received and stored by the information retrieval system.

6. The integrated selling system of claim 3 wherein the identification character string is a telephone number of the person selling the product.

7. The integrated selling system of claim 3 wherein the identification character string is selected by the person selling the product so as to not divulge any person data about the seller.

8. The integrated selling system of claim 3 wherein the information retrieval system is the Internet.

9. The integrated selling system of claim 3 wherein the information retrieval system is a telephone system.

10. An integrated method of selling products comprising the steps of:
displaying an identification character string associated with the product being sold;
activating an information retrieval system by inputting the identification character string.

11. The integrated method of selling products of claim 10 further comprising the step of storing information about the product being sold in the information retrieval system.

12. The integrated method of selling products of claim 11 further comprising the step of accessing a portion of the information retrieval system containing information exclusive to the product being sold by inputting the identification character string displayed on the product into the information retrieval system.

13. The integrated method of selling products of claim 11 wherein the person selling the product generates the identification character string displayed.

14. The integrated method of selling products of claim 11 wherein the person selling the product generates the product information stored in the information retrieval system.

15. The integrated method of selling products of claim 11 wherein the identification character string is a telephone number of the person selling the product.

16. The integrated method of selling products of claim 11 wherein the identification character string is selected by the person selling the product so as to not divulge any person data about the seller.

17. The integrated method of selling products of claim 11 wherein the information retrieval system is the Internet.

18. The integrated method of selling products of claim 11 wherein the information retrieval system is a telephone system.
